(19) United States
(12) Patent Application Publication
(10) Pub. No.: US 2017/0107151 A1
(43) Pub. Date: Apr. 20, 2017

(54) WATER-RESISTANT GYPSUM PRODUCTS AND METHODS

(71) Applicant: United States Gypsum Company, Chicago, IL (US)

(72) Inventors: Paula Hajakian, Naperville, IL (US); Paul W. Reed, Chicago, IL (US)

(21) Appl. No.: 14/886,443

(22) Filed: Oct. 19, 2015

(51) Int. Cl. C04B 28/14; C04B 24/26; B32B 37/14; B32B 13/08; B32B 29/00; C04B 41/49; C04B 24/42

(52) U.S. Cl. CPC C04B 28/14; C04B 41/4961; C04B 24/2652; C04B 24/42; B32B 13/08; B32B 29/002; B32B 37/14; C04B 2111/00603

(57) ABSTRACT

This invention relates to water-resistant gypsum products manufactured with water-based emulsions comprising polymerizable siloxane compound and an anionic polyacrylamide; and methods for making a water-resistant gypsum product, comprising a step of preparing a water-based siloxane emulsion in a turbine emulsifier.

### TECHNICAL FIELD

This invention relates to water-resistant gypsum products and methods in which a polymerizable siloxane compound is emulsified in water to produce a stable emulsion.

### BACKGROUND OF THE INVENTION

Gypsum-based products are commonly used in building construction. Examples of such products include, but are not limited to, interior walls, ceilings, boards, panels, tiles, wall partitions, floor and tile underlayment, coatings and joint compounds.

Natural mineral gypsum is also referred to as calcium sulfate dihydrate, terra alba or landplaster. Synthetic gypsum, which is a byproduct of flue gas desulfurization processes from power plants, may also be used for manufacturing a construction product. Typically, production of a gypsum product requires that gypsum is first calcined into calcium sulfate hemihydrate also referred to as stucco, calcined gypsum or calcium sulfate semihydrate.

A number of useful gypsum products can be made by mixing calcined gypsum with water to form a gypsum slurry and permitting the slurry to set and form a gypsum core by allowing calcium sulfate hemihydrate to react with water, which leads to conversion of calcium sulfate hemihydrate into a matrix of interlocking calcium sulfate dihydrate crystals. As the matrix forms, the gypsum slurry becomes firm and holds a shape. Some gypsum products can be formed by sandwiching a gypsum slurry between two cover sheets, typically paper cover sheets. These gypsum products are commonly referred to as wallboard. Some other gypsum products are formed by compressing a gypsum slurry together with various fibers and without the use of paper cover sheets. These gypsum products are commonly known as fiberboard.

Set gypsum may absorb water in significant amounts. Various methods have been developed to improve water-resistance in gypsum products. U.S. Pat. Nos. 7,811,685 and 7,892,472, assigned to United States Gypsum Company, describe the use of siloxane compounds for improving water-resistance of a gypsum product. In these methods, a siloxane compound is added to a gypsum slurry along with a catalyst, which triggers polymerization and formation of a polymeric silicone matrix while the gypsum slurry sets.

Typically, siloxane compounds are highly hydrophobic, which makes it difficult to mix these compounds with water and obtain a stable emulsion. This problem may become very significant during manufacturing of a gypsum product where a siloxane compound is added to a water-based gypsum slurry.

During manufacturing of a gypsum product, a siloxane compound is mixed with water to form a siloxane emulsion which is then added to a gypsum slurry. Because of the high hydrophobicity of siloxane compounds, a siloxane compound has to be diluted substantially with water during production of a gypsum product, which may increase the amount of water used during production of a gypsum product. In the emulsion, siloxane particles are distributed in water, but keeping the siloxane emulsion stable and preventing agglomeration of the particles is a challenging task. Yet, a consistent and stable siloxane emulsion is highly desirable because siloxane agglomeration and separation from water may lead to uneven polymerization and formation of a gypsum product in which a matrix of interlocking calcium sulfate dihydrate crystals is also uneven. This may lead to a gypsum product with some areas in the product being highly water-resistant and other areas being less water-resistant.

### SUMMARY OF THE INVENTION

This invention provides an emulsifier and system for producing a stable water-based siloxane emulsion in which the size of siloxane particles is controlled and the siloxane particles are prevented from agglomeration.

This invention also provides a water-resistant gypsum product comprising a gypsum core with a silicone/polyacrylamide matrix sandwiched between two sheets of paper. The gypsum core is prepared by: mixing a gypsum slurry comprising calcined gypsum and water with an emulsion comprising a polymerizable siloxane compound and an anionic polyacrylamide; allowing the mixture to set; and thereby forming the gypsum core comprising a silicone/polyacrylamide matrix.

In some embodiments, the anionic polyacrylamide is a high molecular weight polyacrylamide with the molecular weight in the range from about 10,000,000 to about 60,000,000. The anionic polyacrylamide may be a high-molecular weight polyacrylamide selected from the group consisting of: a high-molecular weight polyacrylamide with medium-high anionic charge and a high-molecular weight polyacrylamide with low anionic charge. In some embodiments, the anionic polyacrylamide is hydrolyzed from about 10% to about 50%.

Emulsions in which the average size of siloxane particles is no larger than 20 microns are particularly suitable for obtaining water-resistant gypsum products. Such emulsions can be obtained by subjecting a mixture of a siloxane compound in water to emulsification in a turbine emulsifier. In some embodiments the mixture of a siloxane compound in water is further formulated with at least one anionic polyacrylamide and then subjected to emulsification in a turbine emulsifier.

Further embodiments provide methods for making a gypsum product. These methods comprise a step of feeding a polymerizable siloxane compound and water into a turbine emulsifier; followed by a step of mixing the polymerizable siloxane compound and water until an emulsion is obtained, and then sending a portion of the emulsion into a gypsum slurry mixer. The emulsion is then mixed with a gypsum slurry in the mixer and a gypsum product is formed from the mixture of the gypsum slurry with the emulsion; and the product is allowed to set. The mixing of the polymerizable siloxane compound and water may be performed until the average size of siloxane particles is no larger than 20 microns.

In some embodiments, a suitable siloxane-water emulsion is obtained by mixing together in a turbine emulsifier a polymerizable siloxane compound, water and an anionic polyacrylamide. The mixing of the polymerizable siloxane compound, water and anionic polyacrylamide may be performed until the average size of siloxane particles is no larger than 20 microns. In some embodiments of the method, the polymerizable siloxane compound and the anionic polyacrylamide are mixed such that the final concentration of the polymerizable siloxane compound in the emulsion is from 1% to 40%, by weight of the emulsion; and the final concentration of the anionic polyacrylamide in the emulsion is from 0.01% to 10%, by weight of the emulsion.

### BRIEF DESCRIPTION OF THE DRAWINGS

FIGS. 1A-1C are micrographs for siloxane emulsions. FIG. 1A depicts siloxane particles in a siloxane-water emulsion. FIG. 1B depicts siloxane particles in a siloxane-water emulsion prepared with a high-molecular weight, medium-high charge anionic polyacrylamide polymer. FIG. 1C depicts siloxane particles in a siloxane-water emulsion prepared with a high-molecular weight, low charge anionic polyacrylamide polymer.

FIG. 2 depicts a system for producing a stable siloxane-water emulsion during manufacturing of a gypsum product.

FIG. 3 depicts a graph showing results of a water-resistance test for gypsum wallboards made with siloxane emulsions with siloxane particles of different sizes.

FIGS. 4A-4D are micrographs of a siloxane-water emulsion prepared with anionic polyacrylamide aPOA1. The final concentrations of aPOA1 are as follows: 1.8% of aPOA1 in FIG. 4A; 3.5% of aPOA1 in FIG. 4B; 6.7% of aPOA1 in FIG. 4C and 12.6% of aPOA1 in FIG. 4D.

FIGS. 5A-5C are micrographs of a siloxane-water emulsion prepared with anionic polyacrylamide aPOA2. The final concentrations of aPOA2 are as follows: 2.4% of aPOA2 in FIG. 5A; 3.4% of aPOA2 in FIG. 5B; and 4.3% of aPOA2 in FIG. 5C.

FIGS. 6A-6D are micrographs of a siloxane-water emulsion prepared with anionic polyacrylamide aPOA3. The final concentrations of aPOA3 are as follows: 2.4% of aPOA3 in FIG. 6A; 2.9% of aPOA3 in FIG. 6B; 3.4% of aPOA3 in FIG. 6C; and 3.8% of aPOA3 in FIG. 6D.

FIGS. 7A-7D are micrographs of a siloxane-water emulsion prepared with anionic polyacrylamide aPOA4. The final concentrations of aPOA4 are as follows: 2.4% of aPOA4 in FIG. 7A; 2.9% of aPOA4 in FIG. 7B; 3.4% of aPOA4 in FIG. 7C; and 3.4% of aPOA4 in FIG. 7D.

### DETAILED DESCRIPTION OF THE INVENTION

The present invention provides gypsum products made with an emulsion comprising a polymerizable siloxane compound and anionic polyacrylamide.

The siloxane emulsion comprises at least one polymerizable siloxane compound emulsified in water with at least one anionic polyacrylamide emulsifier. Using an anionic polyacrylamide as an emulsifier provides several technical advantages. The size of siloxane particles in the emulsion is decreased and siloxane particles are prevented from agglomeration. Producing a gypsum product with these emulsions increases water-resistance of the gypsum product. Other advantages include decreasing the amount of water needed for preparing a stable water-based siloxane emulsion.

Various siloxane compounds can be used in these emulsions, including, but not limited to, a fluid linear hydrogen-modified siloxane or a cyclic hydrogen-modified siloxane. The linear hydrogen modified siloxanes useful in the practice of the present invention include those comprising a repeating unit of the general formula:

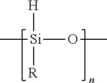

wherein R represents a saturated or unsaturated mono-valent hydrocarbon radical. In the preferred embodiments, R represents an alkyl group.

In further embodiments, suitable modified siloxanes include those comprising the following repeating unit:

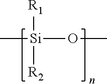

where R₁ and R₂ represent saturated or unsaturated mono-valent hydrocarbon radicals. In some embodiments, R₁ and R₂ are alkyl groups, and most preferably both R₁ and R₂ are a methyl group. Polymerization and cross-linking of a siloxane compound results in formation of a silicone matrix.

In some embodiments, the polymerizable siloxane compound in the emulsion is polymethylhydrogensiloxane (abbreviated as PMHS). In other embodiments, the polymerizable siloxane compound in the emulsion is polydimethylsiloxane (abbreviated as PDMS).

An anionic polyacrylamide (abbreviated as aPOA) is used as an emulsifier. The term “polyacrylamide” is used broadly to mean a polymer comprising the following repeating acrylamide unit.

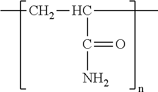

It will be appreciated that “n” is an integer and denotes a number of times the acrylamide unit is repeated in a polyacrylamide. It will be further appreciated that at least in some embodiments, the acrylamide unit may be chemically modified, including by addition of organic and/or inorganic radicals.

It will be further appreciated that in some embodiments, a suitable anionic polyacrylamide is substantially a homopolymer which is comprised predominantly of the repeating acrylamide units. In other embodiments, a suitable anionic polyacrylamide is a heteropolymer, comprising the acrylamide units copolymerized with monomers which differ in chemical structure from acrylamide.

The term “anionic” means negatively charged or capable of becoming negatively charged under particular conditions such as at a certain pH. The term “anionic polyacrylamide” is used in this disclosure broadly and includes polyacrylamides in which anionic (negatively charged) monomers are copolymerized with acrylamide units. The term “anionic polyacrylamide” also includes polyacryamides which have been anionically modified. Such modifications may include hydrolysis of polyacrylamide. Various degrees of hydrolysis are suitable. In some embodiments, the degree of hydrolysis is from about 10% to about 50%. In further embodiments, the degree of hydrolysis is from about 10% to about 40%. In further embodiments, the degree of hydrolysis is from about 10% to about 30%. In further embodiments, the degree of hydrolysis is from about 10% to about 20%.

Suitable anionic polyacrylamides include anionic polyacrylamides with a high-molecular weight. In some embodiments, the anionic high-molecular weight polyacrylamide has a molecular weight in the range from about 5,000,000 to about 100,000,000. In some embodiments, the anionic high-molecular weight polyacrylamide has a molecular weight in the range from about 10,000,000 to about 60,000,000. In some embodiments, the anionic high-molecular weight polyacrylamide has a molecular weight in the range from about 10,000,000 to about 50,000,000. In some embodiments, the anionic high-molecular weight polyacrylamide has a molecular weight in the range from about 15,000,000 to about 60,000,000. In some embodiments, the anionic high-molecular weight polyacrylamide has a molecular weight in the range from about 15,000,000 to about 50,000,000, to about 40,000,000, to about 30,000,000, or to about 20,000,000. In some embodiments, the anionic high-molecular weight polyacrylamide has a molecular weight in the range from about 5,000,000 to about 50,000,000, to about 40,000,000, to about 30,000,000, or to about 20,000,000.

Suitable anionic high-molecular weight polyacrylamides include those with medium-high anionic charge. Suitable high-molecular weight polyacrylamides with medium-high anionic charge include those in which from about 30 to about 60 percent of monomers are anionic or anionically modified, and more preferably those in which from about 40 to about 50 percent of monomers are anionic or anionically modified. Suitable medium-high anionic charge polyacrylamides also include those in which from about 30 to about 60 percent of polyacrylamide is hydrolized, and more preferably from about 40 to about 50 percent of polyacrylamide is hydrolized.

Other embodiments include those in which an anionic high-molecular weight polyacrylamide has low anionic charge. Suitable high-molecular weight polyacrylamides with low anionic charge include those in which from about 5 to about 15 percent of monomers are anionic or anionically modified, and more preferably those in which from about 5 to about 10 percent of monomers are anionic or anionically modified. Suitable low anionic charge polyacrylamides also include those in which from about 5 to about 15 percent of polyacrylamide is hydrolized, and more preferably from about 5 to about 10 percent of polyacrylamide is hydrolized.

A water-based stable emulsion comprising a polymerizable siloxane compound and an anionic polyacrylamide can be prepared by blending together at least one siloxane compound, water and at least one anionic polyacrylamide. In some emulsions, a siloxane compound can be used in the amount from about 1% to about 40%, by weight of the emulsion. In other emulsions, a siloxane compound can be used in the amount from about 5% to about 35% by weight of the total composition. In other emulsions, a siloxane compound can be used in the amount from about 10% to about 30% by weight of the total composition.

An anionic polyacrylamide can be used in different amounts. In some embodiments, the anionic polyacrylamide can be used in the amount from about 0.01% to about 10% by weight of the emulsion. In some embodiments, the anionic polyacrylamide can be used in the amount from about 0.01% to about 5% by weight of the total composition.

Some emulsions are prepared by blending together a polymerizable siloxane compound with water and a high-molecular weight anionic polyacrylamide with medium-high anionic charge. Other emulsions are prepared by blending together a polymerizable siloxane compound with water and a high-molecular weight anionic polyacrylamide with low anionic charge. These emulsions can be prepared in a turbine emulsifier.

Other emulsions are prepared by blending together a polymerizable siloxane compound with water in a turbine emulsifier to obtain an emulsion with the siloxane particle size of no larger than 20 microns on average. In further embodiments, emulsions are prepared by blending together a polymerizable siloxane compound with water and an anionic polyacrylamide in a turbine emulsifier to obtain an emulsion with the siloxane particle size of no larger than 20 microns on average.

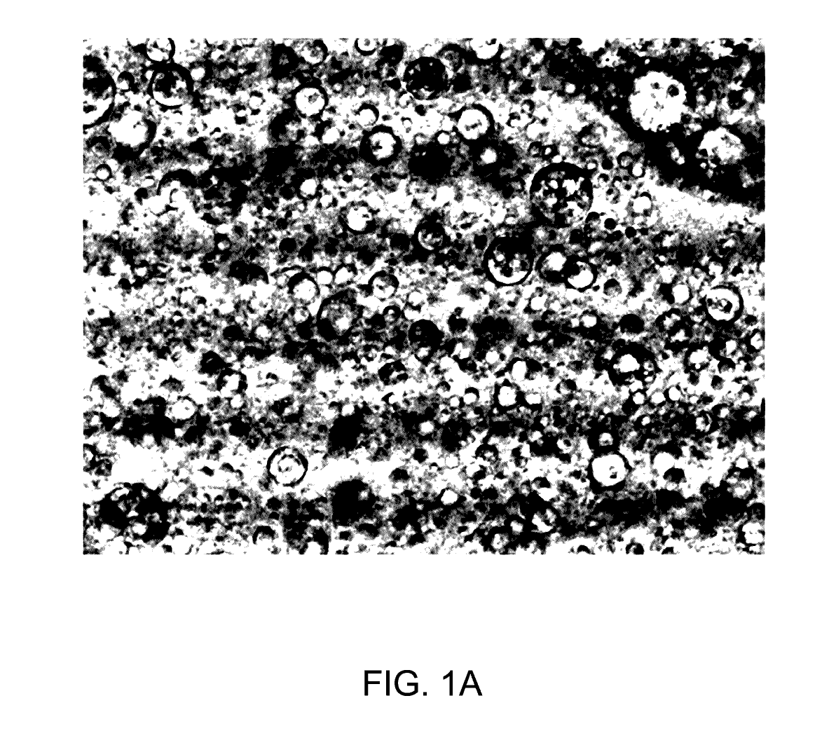

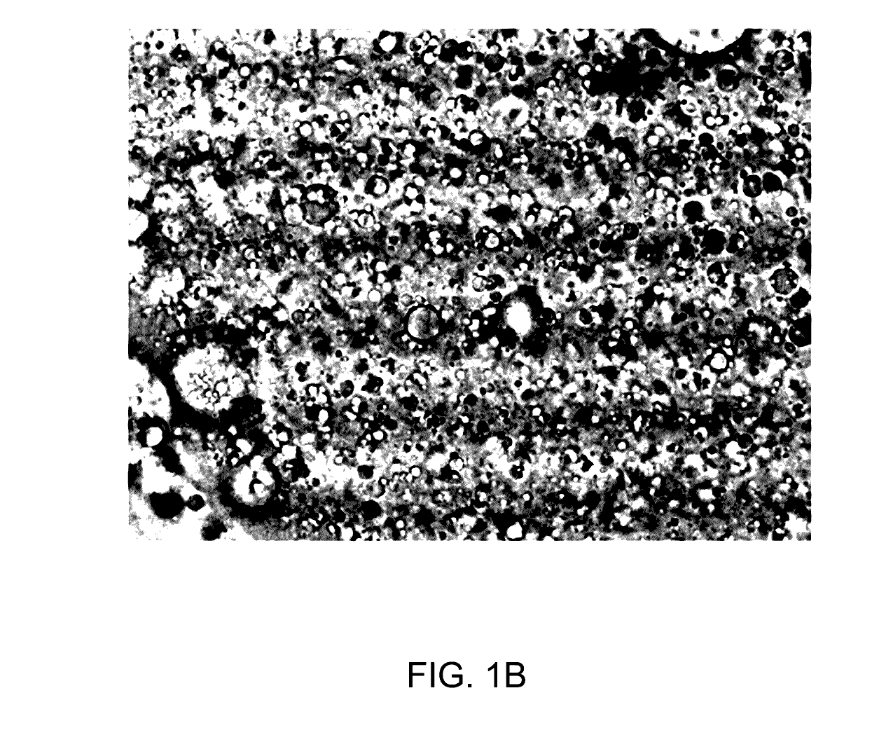

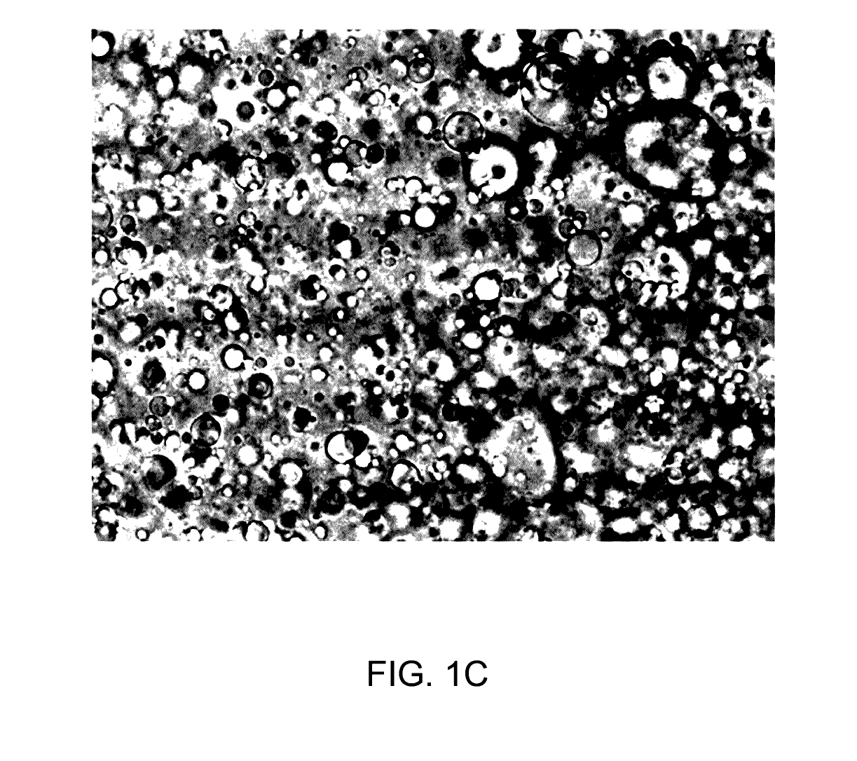

As shown in a micrograph of FIG. 1A, blending a siloxane compound with water produces an emulsion in which particles of the siloxane compound continue to agglomerate into larger particles. Further, even with vigorous mixing, the size of siloxane particles cannot be reduced below a certain average. As shown in FIG. 1 B, using a high-molecular weight, medium-high charge anionic polyacrylamide as an emulsifier, stabilizes the emulsion and reduces the size of siloxane particles in comparison to the control emulsion of FIG. 1A. As also shown in FIG. 1C, using a high-molecular weight, low-charge anionic polyacrylamide as an emulsifier also stabilizes the siloxane emulsion and reduces the size of siloxane particles in comparison to the control emulsion of FIG. 1A.

The inventors have discovered that reducing the average size of siloxane particles in a water-based emulsion increases water-resistance of a gypsum product made with the emulsion. In some embodiments, a significant increase in water-resistance of a gypsum product may be achieved by using a siloxane emulsion in which the average size of siloxane particles is decreased to 20 microns and smaller.

Some embodiments provide methods in which a polymerizable siloxane emulsion is prepared by vigorous mixing and until the size of siloxane particles in the emulsion is no larger than 20 microns. At least in some embodiments, the method is performed by using a turbine emulsifier.

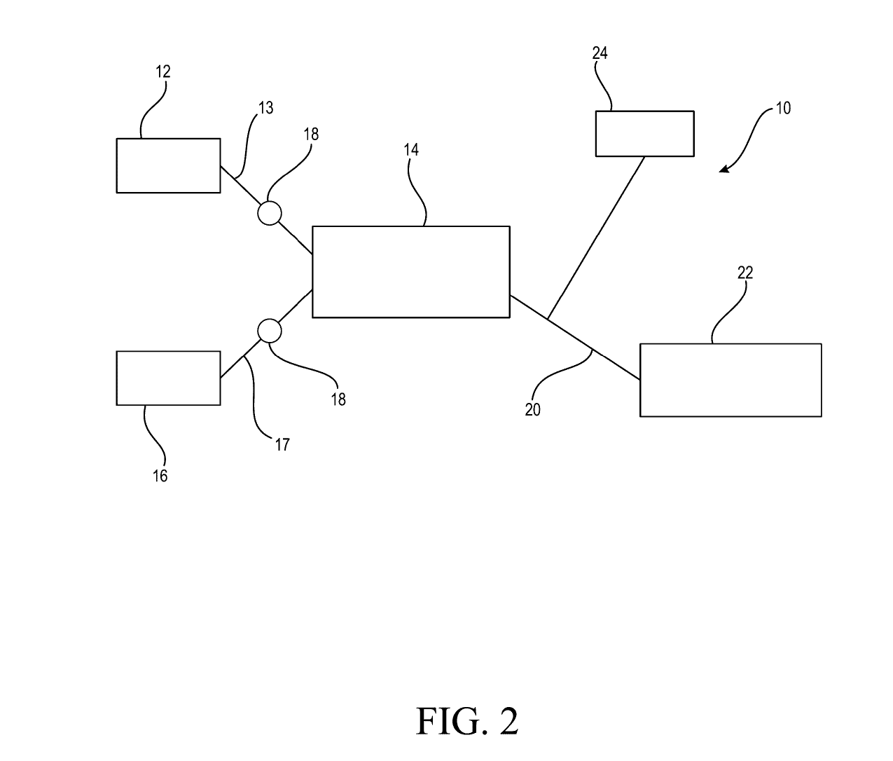

Further embodiments provide a system and method by which a stable emulsion of siloxane with smaller siloxane particles in water is produced. One embodiment for this system, generally 10, is shown in FIG. 2. The system 10 comprises a pump 12 which feeds a polymerizable siloxane solution into a turbine emulsifier device 14 through a pipe 13. A pump 16 feeds an anionic polyacrylamide into the turbine emulsifier device 14 through a pipe 17. It will be appreciated that at least in some embodiments, the same pump 12 can be used for feeding both the polymerizable siloxane solution and an anionic polyacrylamide into the turbine emulsifier device 14. In some embodiments, the system 10 can be used for producing a stable siloxane emulsion with smaller siloxane particles without the use of an anionic polyacrylamide.

The system 10 is equipped with a plurality of flow measurement devices 18. These devices measure and maintain the proper ratio of siloxane to emulsifier and water. The turbine emulsifier device 14 is connected by a pipe 20 with a gypsum slurry mixer 22. A monitoring device 24 is in communication with the emulsifier 14 and pipe 20. The siloxane emulsion monitoring device 24 monitors the size of siloxane particles produced in the turbine emulsifier device 14.

The device 24 may comprise a camera and/or laser or some other sensor means that monitor the size of siloxane particles produced in the emulsifier. The device 24 may be further connected to a computer which is equipped with software that triggers a signal if the average size of siloxane particles in the emulsion increases over the preset maximum.

Further embodiments include the system 10 with a feedback loop from the device 24 to the devices 12, 14 and 16. This feedback loop re-adjusts the flow-rate and concentrations of water, siloxane and anionic polyacrylamide and also controls the speed of the turbine emulsifier device 14 to reduce the size of siloxane particles to a predetermined size. In some embodiments, the system 10 is set up such that a siloxane emulsion is produced with siloxane particles no larger than 50 microns on average, no larger than 45 microns on average, no larger than 40 microns on average, no larger than 35 microns on average, no larger than 30 microns on average, or no larger than 25 microns on average. In some embodiments the system 10 is set up such that a siloxane emulsion is produced with siloxane particles no larger than 20 microns on average.

Further embodiments provide moisture-resistant and mold-resistant gypsum products produced with the stabilized polymerizable siloxane emulsion comprising at least one polymerizable siloxane compound emulsified in water with at least one anionic polyacrylamide emulsifier. These products include wallboard. Some embodiments include wallboard and foamed gypsum products.

The stabilized polymerizable siloxane emulsion comprising at least one polymerizable siloxane compound emulsified in water with at least one anionic polyacrylamide emulsifier can be added to a gypsum slurry prepared from at least water and calcined gypsum, and optionally with other components such as at least one of a surfactant, binder, foam, defoamer, filler, fiber, set accelerator, set retarder, dispersant, biocide and fungicide. Some embodiments may include adding foam for preparing foamed gypsum products as disclosed in U.S. Pat. No. 5,683,635, incorporated herein by reference.

The emulsion can be added in any amount suitable for obtaining a moisture-resistant gypsum product. In some embodiments, the emulsion is added to a gypsum slurry in the amount from about one pound of siloxane compound added per one thousand square feet of gypsum board produced (abbreviated as 1 lbs/MSF) to about thirty pounds of siloxane compound added per one thousand square feet of gypsum board produced (abbreviated as 30 lbs/MSF).

A catalyst which promotes polymerization of siloxane to form a silicone matrix may be added to the gypsum slurry. Such catalysts include dead-burned magnesium oxide which can be further mixed with class C fly ash, as provided in U.S. Pat. Nos. 7,811,685 and 7,892,472, incorporated herein by reference. The dead-burned magnesium oxide is preferably used in amounts of about 0.1 to about 0.5%, based on the dry calcined gypsum weight.

Suitable dispersants include, but are not limited to, polycarboxylates, sulfonated melamines or naphthalene sulfonate.

A trimetaphosphate compound can be added to the gypsum slurry in some embodiments to enhance the strength of the product and to improve sag resistance of the set gypsum. Preferably the concentration of the trimetaphosphate compound is from about 0.07% to about 2.0% based on the weight of the calcined gypsum. Gypsum compositions including trimetaphosphate compounds are disclosed in U.S. Pat. Nos. 6,342,284 and 6,632,550, both patents incorporated herein by reference.

Other additives may be also added to the gypsum slurry as are typical for the particular application to which the gypsum slurry will be put. Set retarders (up to about 2 lb./MSF (9.8g/m2)) or dry accelerators (up to about 35 lb./MSF (170 g/m2)) can be added to modify the rate at which the hydration reactions take place. “CSA” is a set accelerator comprising 95% calcium sulfate dihydrate co-ground with 5% sugar and heated to 250° F. (121° C.) to caramelize the sugar. CSA is available from United States Gypsum Company, Southard, OK plant, and is made according to U.S. Pat. No. 3,573,947, herein incorporated by reference. Potassium sulfate is another preferred accelerator. HRA is calcium sulfate dihydrate freshly ground with sugar at a ratio of about 5 to 25 pounds of sugar per 100 pounds of calcium sulfate dihydrate. It is further described in U.S. Pat. No. 2,078,199, which is incorporated herein by reference.

Other potential additives to a gypsum slurry are biocides, including boric acid, pyrithione salts and copper salts. A gypsum slurry optionally can include a starch, such as a pregelatinized starch or an acid-modified starch. Starches are used in amounts of from about 3 to about 20 lbs/MSF (14.6 to 97.6 g/m²). Other known additives may be used as needed to modify specific properties of the product.

Glass fibers may be optionally added to a gypsum slurry in amounts of up to 11 lb./MSF (54 g/m²). Up to 15 lb./MSF (73.2 g/m²) of paper fibers may also be added to the gypsum slurry.

In some embodiments, a gypsum slurry comprising a siloxane/anionic polyacrylamide emulsion can be prepared by using the system 10, as described in connection with FIG. 2.

In wallboard manufacturing, a first sheet of paper is rolled out and a gypsum slurry comprising the siloxane/anionic polyacrylamide emulsion is deposited and spread over the first sheet of paper. A second sheet of paper is then rolled over the gypsum slurry which is now sandwiched between two sheets of paper. With time, siloxane polymerizes into a silicone matrix which incorporates gypsum, polyacrylamide and other components from the gypsum slurry. Thus, the resulting set gypsum product comprises a gypsum core with a silicone/polyacrylamide matrix.

Many gypsum products are required to be moisture-resistant. In order to qualify as a moisture-resistant gypsum product per ASTM C-1396 (standard specification for gypsum board), the gypsum product must not absorb more than 5% of water, based on the total weight of the gypsum product, in a water immersion test during which the gypsum product remains fully submerged in water for two hours.

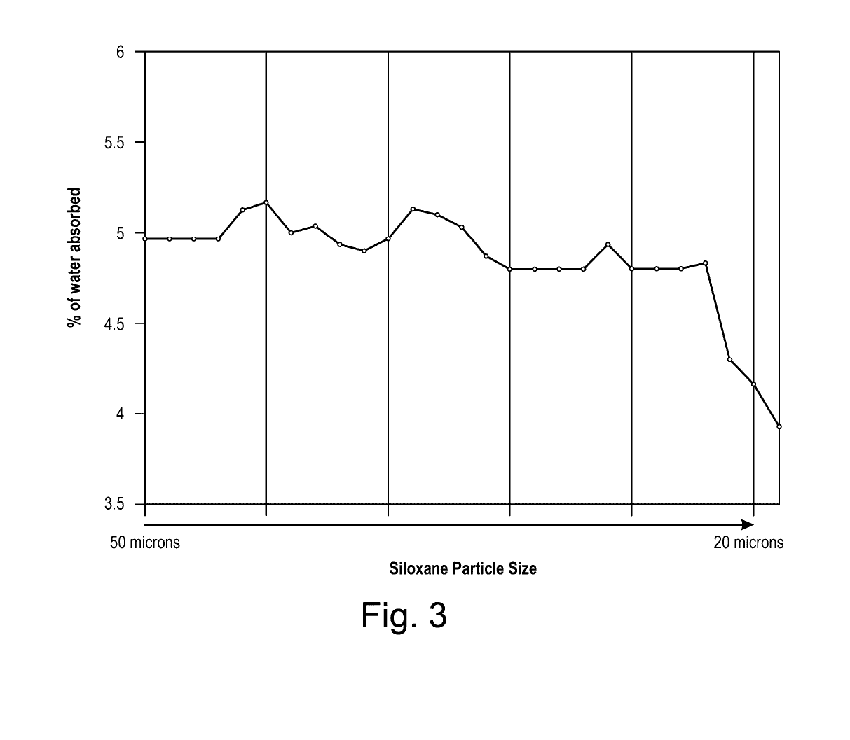

In one embodiment, significant technical advantages were observed when the water immersion test under ASTM C-1396 was conducted for wallboards prepared with a siloxane emulsion in which the average size of siloxane particles was no more than 20 microns. The same water immersion test was conducted for wallboard obtained with a siloxane emulsion in which siloxane particles were larger than 20 microns, and in some samples the siloxane particles were as large as 50 microns and larger. As can be seen from FIG. 3, wallboards obtained with a siloxane emulsion in which siloxane particles were no larger than 20 microns satisfy less than 5% water absorption requirement under ASTM C-1396. The invention will be now explained by the way of the following non-limiting examples.

### EXAMPLE 1

### Preparation of Siloxane/Anionic Polyacrylamide Emulsions

A 30% solution of polymethylhydrogensiloxane (PMHS, CAS 72319-10-9) by weight in water was prepared. One of four anionic polyacrylamides (aPOA 1, aPOA 2, aPOA3 or aPOA4) was added from a 1% stock solution to various final concentrations as provided in Table 1 below. All emulsions were prepared by vigorous mixing and analyzed under the microscope for size and distribution of siloxane particles.

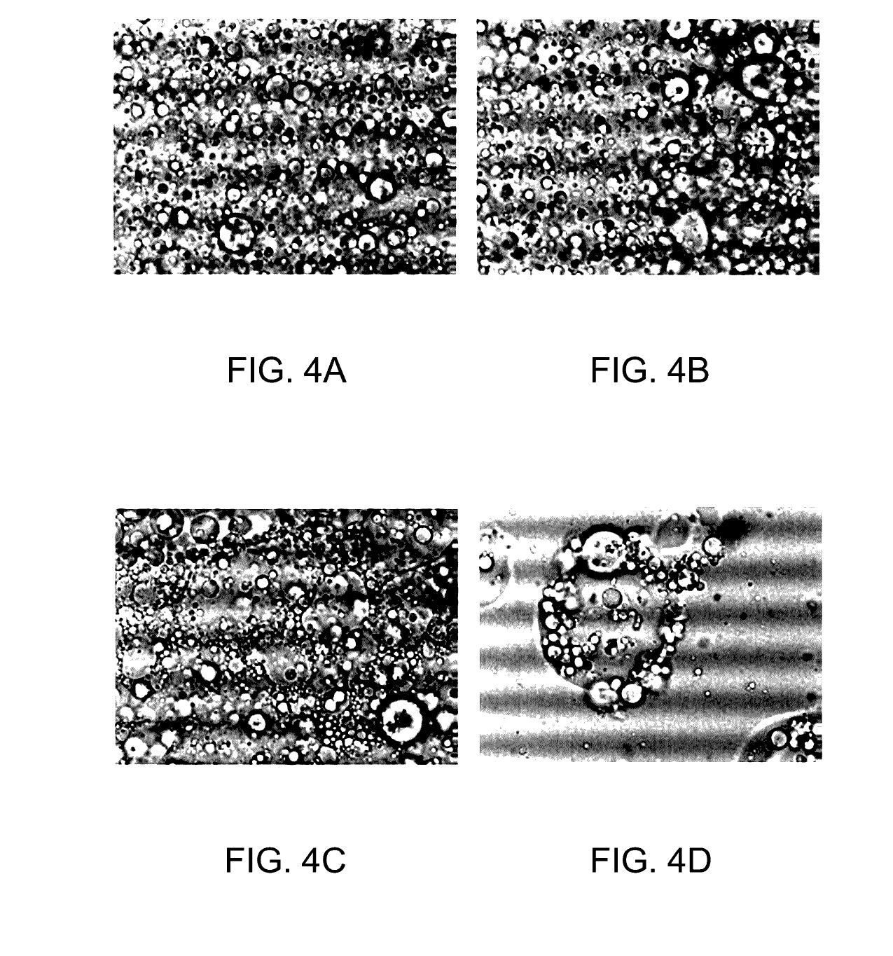

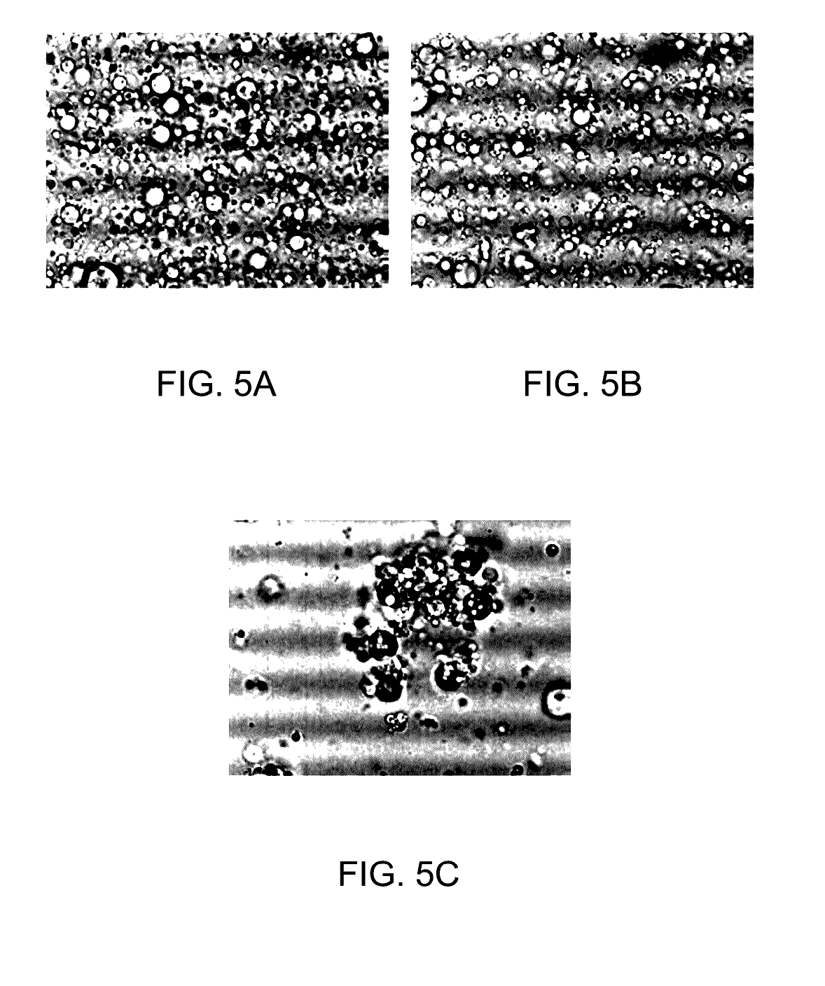

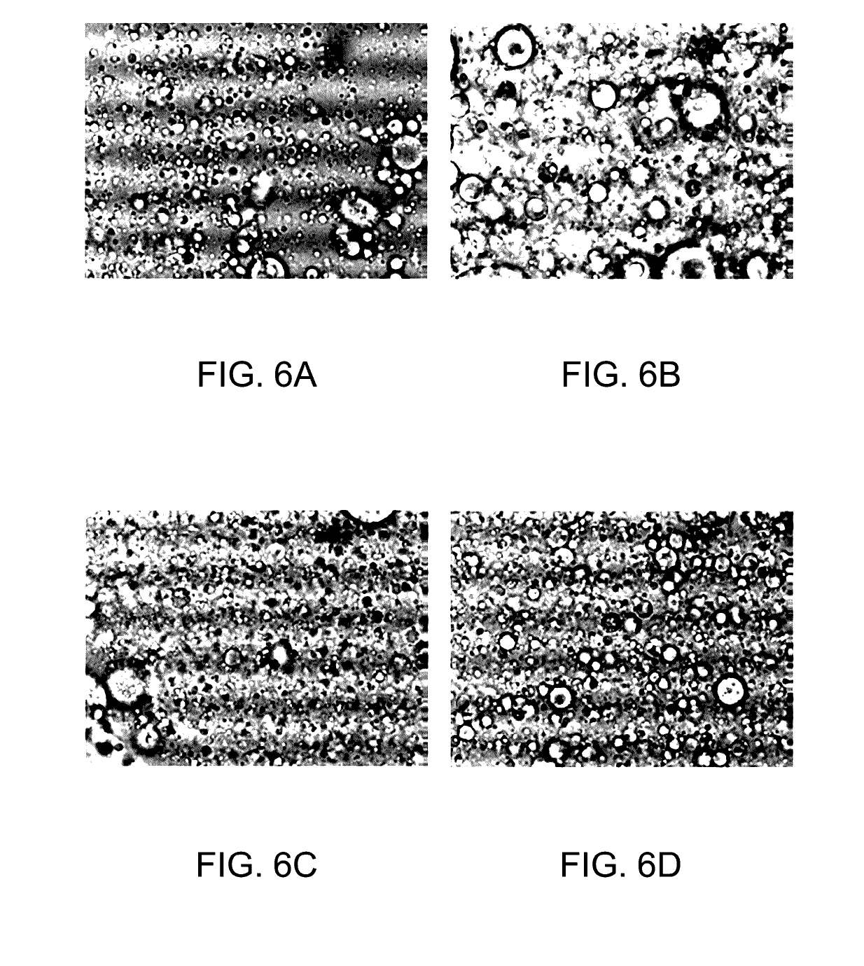

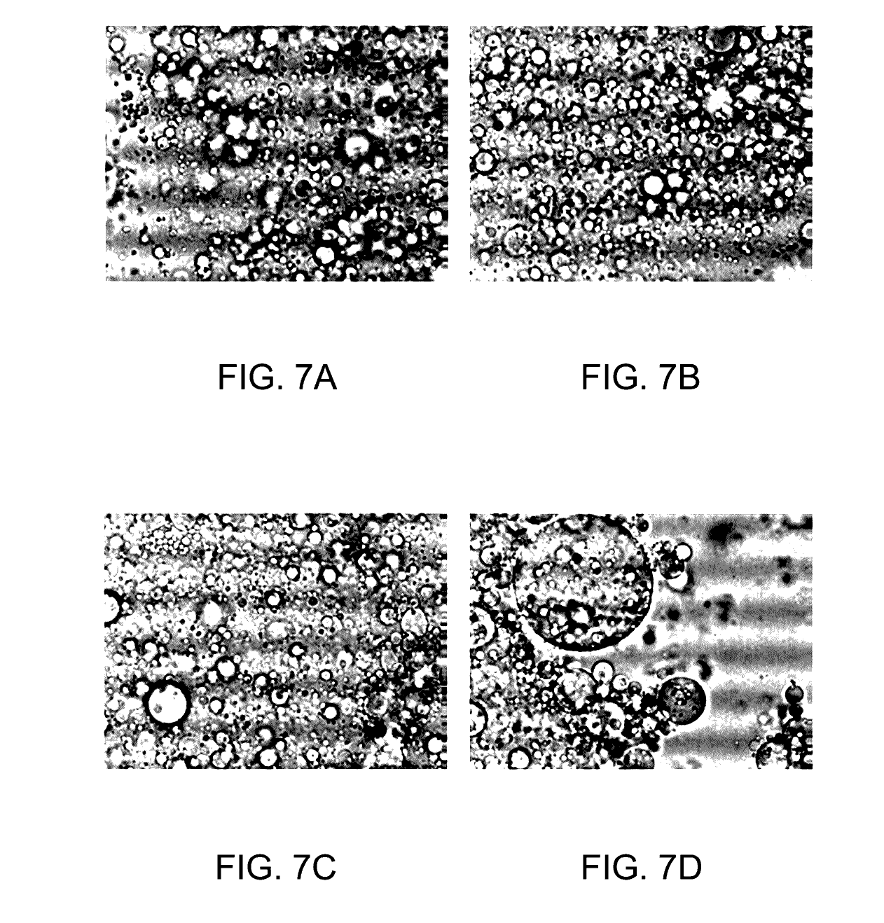

TABLE 1

| | | Final | |
|---|---|---|---|
| Anionic | | Concentrations | |
| Polyacrylamide | | in PMHS | |
| Sample | Composition | emulsion | Observations |
| aPOA1 | Anionic | 1.8%; 3.5%; | Very good |
| | polyacrylamide; | 6.7%; and 12.6% | results at low |
| | MW 9-16 MM; | | concentrations. |
| | CRD DEN 10% | | See FIGS. 4A-4D |
| | (Mol %) | | |
| aPOA2 | Anionic high- | 2.4%; 3.4%; and | Did not prevent |
| | molecular weight | 4.3% | siloxane |
| | polyacrylamide; | | particle |
| | CRD DEN 60% | | agglomeration. |
| | (Mol %) | | See FIGS. 5A-5C |
| aPOA3 | Anionic | 2.4%; 2.9%; | Very good |
| | polyacrylamide; | 3.4%; and 3.8% | performance, |
| | MW 18-30 MM; | | small siloxane |
| | CRD DEN 40% | | particles. See |
| | (Mol %) | | FIGS. 6A-6D |
| aPOA4 | Anionic | 2.4%; 2.9%; and | Did not prevent |
| | polyacrylamide; | 3.4% | siloxane |
| | MW 11-19MM; | | particle |
| | CRD DEN 20% | | agglomeration |
| | (Mol %) | | at lower |
| | | | concentrations. |
| | | | See FIGS. 7A-7D |

Images for the emulsions are shown in FIGS. 4, 5, 6 and 7.

Additional emulsions were prepared with 30% PMHS, 30% PMHS plus aPOA 3 to final concentration of 3.4% by weight of the composition, and 30%PMHS plus aPOA 1 to final concentration of 3.5% by weight of the composition. All three emulsions were analyzed for siloxane particle size. As can be seen in FIGS. 1A-1C, formulations with aPOA 3 (see FIG. 1B) and with aPOA 1 (see FIG. 1C) decrease the size of siloxane particles in comparison to the size of siloxane particles in the 30% PMHS emulsion without an anionic polyacrylamide added (see FIG. 1A).

### EXAMPLE 2

### Testing Wallboard for Water-Resistance

A gypsum slurry was prepared with a siloxane emulsion and sandwiched between paper cover sheets. The wallboards were allowed to dry and were weighed. The weights were recorded. Wallboards were immersed in water for 2 hours and weighed again. The water absorption rate was calculated as a difference in the two weight measurements in percent from the pre-immersion weight.

As shown in FIG. 3, wallboards made from emulsions in which siloxane particles on average were no larger than 20 microns absorb less water than wallboards made with an emulsion in which the size of siloxane particles is on average 50 microns and larger as noted by comparing the left side of the graph in FIG. 3 with the right side of the graph in FIG. 3. This result supports a conclusion that using a siloxane emulsion in which the size of siloxane particles in decreased to about 20 microns or smaller increases water resistance of a gypsum wallboard.

What is claimed is:

1. A gypsum product comprising a gypsum core sandwiched between two sheets of paper, wherein the gypsum core comprises a silicone/polyacrylamide matrix and wherein the gypsum core is prepared by:
mixing a gypsum slurry comprising calcined gypsum and water with an emulsion comprising a polymerizable siloxane compound and an anionic polyacrylamide;
allowing the mixture to set; and
thereby forming the gypsum core comprising the silicone/polyacrylamide matrix.

2. The gypsum product of claim 1, wherein the anionic polyacrylamide is a high molecular weight polyacrylamide with the molecular weight in the range from about 10,000,000 to about 60,000,000.

3. The gypsum product of claim 1, wherein the anionic polyacrylamide is a high-molecular weight polyacrylamide selected from the group consisting of: a high-molecular weight polyacrylamide with medium-high anionic charge and a high-molecular weight polyacrylamide with low anionic charge.

4. The gypsum product of claim 1, wherein about 10% to 50% of the anionic polyacrylamide is hydrolyzed.

5. The gypsum product of claim 1, wherein the anionic polyacrylamide is a high-molecular weight homopolymer and wherein about 30% to about 60% of the high-molecular weight homopolymer is hydrolyzed.

6. The gypsum product of claim 1, wherein the anionic polyacrylamide is a high-molecular weight homopolymer and wherein about 5% to about 15% of the high-molecular weight homopolymer is hydrolyzed.

7. The gypsum product of claim 1, wherein the polymerizable siloxane compound is selected from the group consisting of polymethylhydrogensiloxane and polydimethylsiloxane.

8. The gypsum product of claim 1, wherein the emulsion comprises the polymerizable siloxane compound in the amount from about 1% to about 40%, by weight of the emulsion.

9. The gypsum product of claim 1, wherein the emulsion comprises the anionic polyacrylamide in the amount from about 0.01% to about 10% by weight of the emulsion.

10. The gypsum product of claim 1, wherein the average size of siloxane particles in the emulsion is no larger than 20 microns.

11. The gypsum product of claim 1, wherein the gypsum slurry further optionally comprises at least one of: a surfactant, binder, foam, defoamer, filler, fiber, set accelerator, set retarder, dispersant, biocide and fungicide.

12. The gypsum product of claim 11, wherein the gypsum slurry further comprises a compound is selected from the group consisting of dead-burned magnesium oxide, class C fly ash, and the combination of dead-burned magnesium oxide; and the selected compound is added to the gypsum slurry.

13. A method of making a gypsum product, the method comprising:
feeding a polymerizable siloxane compound and water into a turbine emulsifier;
mixing the polymerizable siloxane compound and water until an emulsion is obtained;
sending a portion of the emulsion into a gypsum slurry mixer;
mixing the emulsion with a gypsum slurry in the mixer;
forming a gypsum product from the mixture of the gypsum slurry with the emulsion; and
allowing the gypsum product to set.

14. The method of claim 13, wherein the mixing of the polymerizable siloxane compound and water is monitored for size of siloxane particles in the emulsion.

15. The method of claim 13, wherein the mixing of the polymerizable siloxane compound and water into the emulsion is performed until the average size of siloxane particles in the emulsion is no larger than 20 microns.

16. The method of claim 13, wherein an anionic polyacrylamide is fed into the turbine emulsifier and is mixed with the polymerizable siloxane compound and water until the emulsion is obtained.

17. The method of claim 16, wherein the mixing of the polymerizable siloxane compound, water and anionic polyacrylamide is monitored for size of siloxane particles in the emulsion.

18. The method of claim 16, wherein the mixing of the polymerizable siloxane compound, water and anionic polyacrylamide into the emulsion is performed until the average size of siloxane particles in the emulsion is no larger than 20 microns.

19. The method of claim 13, wherein the step of forming the gypsum product comprises sandwiching the mixture of the gypsum slurry and the emulsion between two paper sheets.

20. The method of claim 16, wherein the polymerizable siloxane compound and the anionic polyacrylamide are mixed in the amounts such that the final concentration of the polymerizable siloxane compound in the emulsion is from 1% to 40%, by weight of the emulsion; and the final concentration of the anionic polyacrylamide in the emulsion is from 0.01% to 10%, by weight of the emulsion.
